(19) United States
(12) Patent Application Publication
(10) Pub. No.: US 2006/0191754 A1
(43) Pub. Date: Aug. 31, 2006

(54) Air guide arrangement on a motor vehicle front or rear axle

(75) Inventor: Vilem Toman, Wiernsheim (DE)

Correspondence Address: CROWELL & MORING LLP;INTELLECTUAL PROPERTY GROUP, P.O. BOX 14300, WASHINGTON, DC, 20044-4300, US

(73) Assignee: DR. ING. H.C.F. PORSCHE AG, WEISSACH (DE)

(21) Appl. No.: 11/346,343

(22) Filed: Feb. 3, 2006

(30) Foreign Application Priority Data
Feb. 4, 2005 (DE) 102005005113.8-21

(51) Int. Cl. F16D 65/847

(52) U.S. Cl. 188/264 AA

(57) ABSTRACT

An air guide arrangement for a motor vehicle axle has a baffle element which is vertically mounted to a steering knuckle arm and has two air baffle plates positioned at an angle relative to one another. To prevent swiveling vehicle components from interferingly knocking against the baffle element, the baffle element has elastic contact regions in the displacement ranges of the vehicle components. The baffle element is furthermore provided with two air guide channels, which positively guide inflowing air to the brakes in a specific and focused manner.

This application claims the priority of DE 102005005113.8-21, filed Feb. 4, 2005, the disclosure of which is expressly incorporated by reference herein.

### BACKGROUND AND SUMMARY OF THE INVENTION

The present invention relates to an air guide arrangement on a motor vehicle front or rear axle to supply air to a brake rotor of a vehicle brake, wherein the air guide arrangement comprises a baffle element fixed to the wheel control arm and forms a vertical air baffle plate oriented counter to the air stream.

EP 0 331 888 A1 discloses an air guide arrangement for cooling wheel brakes, comprising a baffle element positioned counter to an incoming air stream, which on the vehicle side is mounted to a vehicle control arm. DE 31 07 692 A1 discloses a baffle element which forms an air guide channel by way of turned-up sides and which diverts the air stream flowing along under the vehicle to a brake, thereby cooling the brake.

It is an object of the invention to provide an air guide arrangement which has a relatively large baffle plate to guide the air and which furthermore ensures an unhindered movement of vehicle components during a steering process and deflection and release.

According to the invention this object has been attained by providing that the baffle element comprises two rigid baffle plates which are positioned at an angle relative to one another and have a common angled section at the upper edge in which are disposed at least two elastic contact regions for vehicle components that are to be swiveled (tire and steering knuckle arm).

Among the primary advantages achieved by the present invention are that there is no damage to and/or hindrance of the vehicle components in motion sequences caused by steering processes, and that deflection and release can occur because the baffle element, which extends into the displacement paths of the vehicle components such as a vehicle wheel and a steering knuckle arm, is equipped with corresponding local elastic regions.

According to the present invention, the baffle element, in particular, consists of two rigid baffle plates positioned at an angle relative to one another and having a common angled section at the upper edge in which are disposed at least two elastic contact regions for vehicle components. This configuration of the baffle element with the elastic contact regions makes it possible to achieve a large-surface baffle element and thus a large air baffle plate which can even project into the displacement paths of the adjoining vehicle components without impeding them.

In this connection, it is further provided according to the present invention that the elastic contact region for a tire is disposed at the inner end of the angled section of the one baffle plate and the additional elastic contact region for the steering knuckle arm at the outer end of the angled section of the baffle plate facing the brake rotor. The elastic contact region at the outer end of the angled section partially extends from this angled section into the baffle plate.

According to the present invention, it is furthermore provided that the elastic contact region at the outer end of the angled section and the baffle plate extends further into the baffle plate in a first edge-side section having one depth than an adjoining second section having a lesser depth. This creates specific elastic regions, such that particularly the displacement path of the steering knuckle arm is taken into account and an elastic contact region is created along the edge which has a greater depth in the baffle plate than the adjoining additional elastic region.

To enable the tie rod of the vehicle's steering assembly to be freely guided through the baffle element, a passage opening is provided in the baffle element which is configured to correspond to the displacement curve. To mount the tie rod or slip on the baffle element, the passage opening has a parting point in the angled section, which is held together by a locking element. According to the invention, the passage opening may also be closed around the tie rod by way of elastic wall sections.

To achieve a positively guided and specific airflow to the brake or the brake rotor, an upper air guide channel is formed between the upper edge-side angled section of the baffle element and a web that is disposed in a partial region approximately in the center in the baffle plates, and an additional air guide channel is formed between this web and a lower edge-side angled section that is disposed in a partial region. Thus, the two air guide channels on the baffle element allow the inflowing air to be positively guided in a defined direction, without any losses, directly to the brake rotor, as a focused air stream.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of the installed baffle element on a front axle of a motor vehicle,

FIG. 2 is a front view of the baffle element of FIG. 1 showing elastic contact regions,

FIG. 3 is a top view of the baffle element corresponding to FIG. 2,

FIG. 4 is a sectional view of the baffle element taken along line IV-IV of FIG. 3, and

FIG. 5 is a side view of the baffle element as seen in the direction of arrow Z of FIG. 2.

### DETAILED DESCRIPTION OF THE DRAWINGS

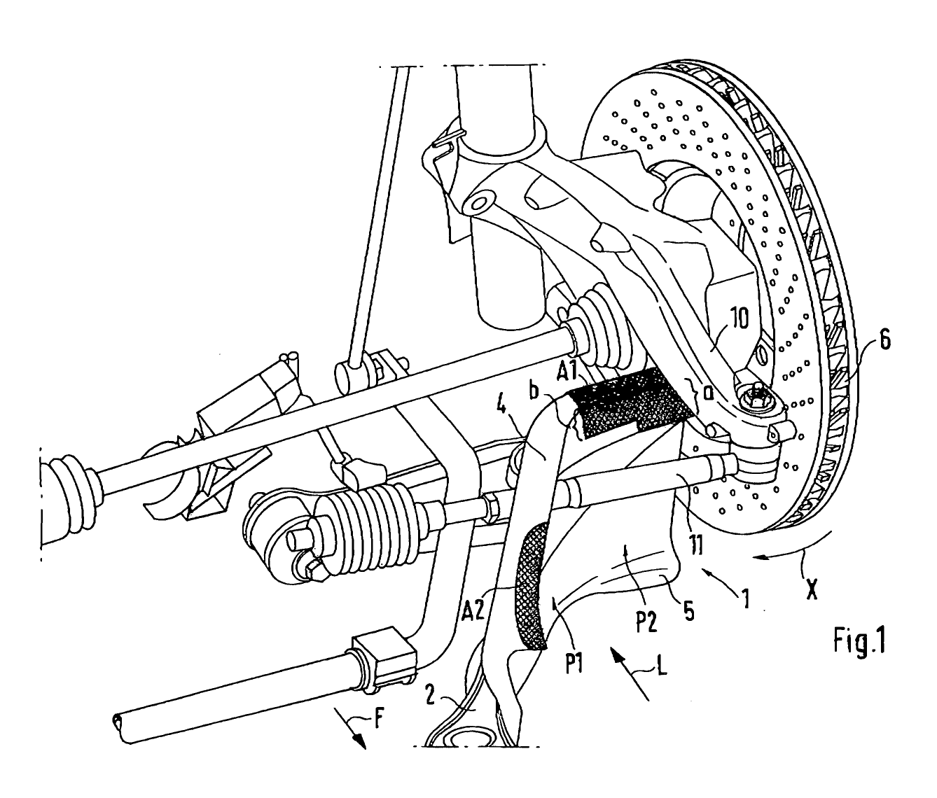

As may be seen in greater detail in FIG. 1, a rigid baffle element 1 for an incoming air stream L is disposed vertically in relation to the driving direction F and can be firmly clipped or held onto a wheel control arm 2. The baffle element 1 comprises air baffle plates P1,P2 which are delimited by an upper continuous angled or bent section 4 in driving direction F and a lower partial additional angled or bent section 5. To catch and guide the incoming air stream L, the baffle plates P1,P2 of the baffle element 4 are divided into two areas which are positioned at an angle α relative to one another (FIG. 3).

In the upper angled section 4 and in the baffle plate P2, a first elastic contact region A1 and a second elastic contact region A2 are provided. The first elastic contact region A1 is disposed at the outer end of the baffle element 1 facing a brake rotor 6. The second elastic contact element A2 is provided at the end of the baffle element 1.

The elastic contact region A1 extends partially from the angled section 4 into the baffle plate P2 and has a stepped configuration, such that the elastic region delimited directly by the edge of the baffle plate P2 has a depth of a dimension (a) and the other adjoining elastic region has a lesser depth of a dimension (b).

The elastic contact region A1 in the baffle element 4 serves to enable unimpeded movement in the direction of arrow X in case of a steering movement of the steering knuckle arm 10, such that the swivel movement of the steering arm 10 is taken into account. The additional elastic contact region A2 can be elastically pushed aside for a steering angle and represents no hindrance for the vehicle wheel.

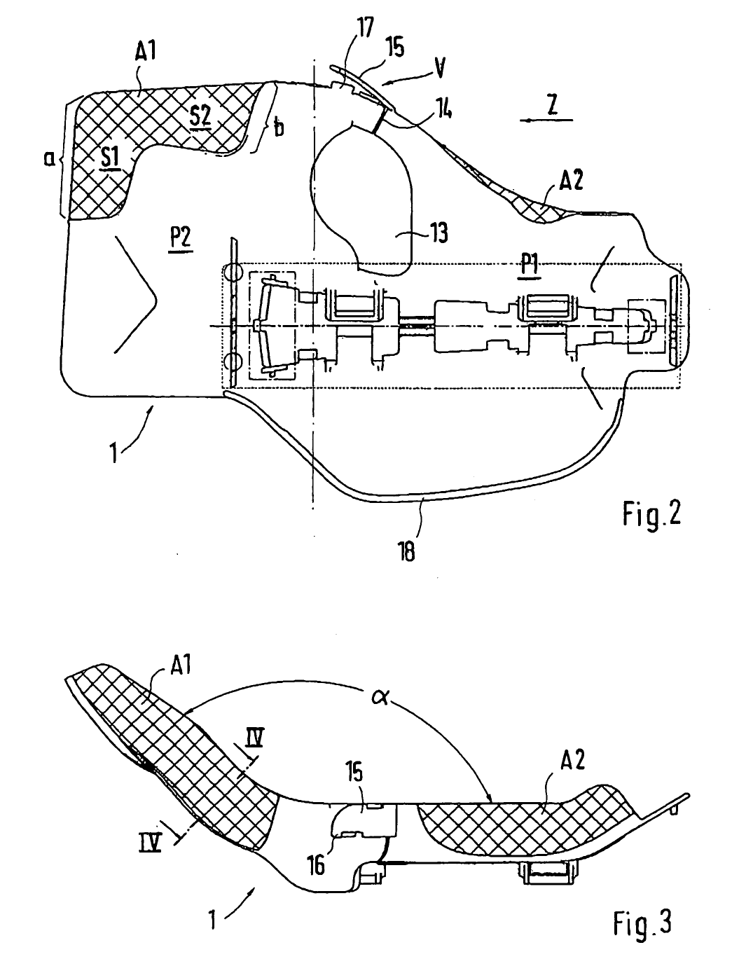

To enable a tie rod 11 to be guided through from the steering gear (not depicted) to the steering knuckle arm 10 without any interference by the baffle element 4, the baffle element 4 has a passage opening 13, the size of which is dimensioned to correspond to the possible motion in space. To thread the tie rod 11 from the outside into the baffle element 1, the baffle element has an opening 13 (FIG. 2) with a parting point 14 which can be closed by a clip 15 that is formed onto the baffle element. The clip 15 has a hook 16 (FIG. 3) which clampingly overlaps a projection 17 on the angled section 4, The passage opening 13 may be closed by elastic wall sections surrounding the tie rod 11.

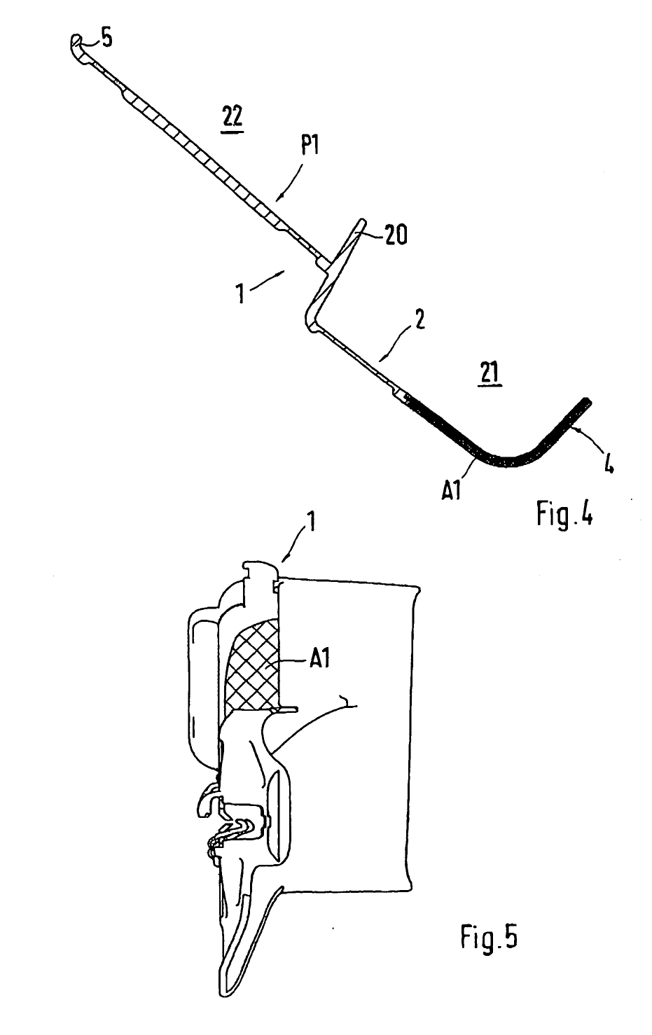

In the baffle plates P1,P2 of the baffle element 4, between the upper continuous angled section 4 and a web 20 (FIG. 4) formed between the angled sections 4,5, a first upper air guide channel 21 is formed, such that the web 20 extends approximately parallel to and is spaced apart from the angled section 4. A second lower air guide channel 22 is formed between the web 20 and the lower angled section 5 which is provided in a partial region.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Air guide arrangement on a motor vehicle axle to supply air to a brake rotor, comprising a baffle element operatively fixed to the wheel control arm to form a vertical air baffle plate oriented counter to the air stream,
wherein the baffle element includes rigid baffle plates which are positioned at an angle relative to one another and have a common angled section at the upper edge at which are disposed at least two elastic contact regions for vehicle components that are adapted to be swiveled.

2. Air guide arrangement as claimed in claim 1, wherein one of the elastic contact regions is provided for a tire and is disposed at the inner end of the angled section of one of the baffle plates, and another of the elastic contact regions is provided for a steering knuckle arm and is disposed at an outer end of another of the baffle plates which is oriented toward the common angled section of the brake rotor.

3. Air guide arrangement as claimed in claim 1, wherein another of the elastic contact regions is arranged at the outer end of the common angled section so as to partially extends from the angled section into another of the baffle plates.

4. Air guide arrangement as claimed in claim 2, wherein another of the elastic contact regions is arranged at the outer end of the common angled section and another of the baffle plates extends further into another of the baffle plates in a first edge-side section with a first depth dimension than in an adjoining second section with a second depth dimension.

5. Air guide arrangement as claimed in claim 1, wherein a passage opening corresponding to a displacement curve is provided in the baffle element and has a parting point in the common angled section which is arranged to be held together by a locking element.

6. Air guide arrangement as claimed in claim 5, wherein the locking element comprises a clip which clampingly encompasses a projection on the common angled section with a hook.

7. Air guide arrangement as claimed in claim 1, wherein an upper air guide channel is provided in the baffle plates between the common angled section and an approximately central web disposed in a partial region, and another air guide channel is provided between the central web and a lower edge-side angled section disposed in a partial region.

8. Air guide arrangement as claimed in claim 7, wherein one of the elastic contact regions is provided for a tire and is disposed at the inner end of the angled section of one of the baffle plates, and another of the elastic contact regions is provided for a steering knuckle arm and is disposed at an outer end of another of the baffle plates which is oriented toward the common angled section of the brake rotor.

9. Air guide arrangement as claimed in claim 8, wherein another of the elastic contact regions is arranged at the outer end of the common angled section so as to partially extends from the angled section into another of the baffle plates.

10. Air guide arrangement as claimed in claim 8, wherein another of the elastic contact regions is arranged at the outer end of the common angled section and another of the baffle plates extends further into another of the baffle plates in a first edge-side section with a first depth dimension than in an adjoining second section with a second depth dimension.
